(19) United States
(12) Patent Application Publication
(10) Pub. No.: US 2022/0308163 A1
(43) Pub. Date: Sep. 29, 2022

(54) MULTITARGET CONSTANT FALSE ALARM RATE DETECTION METHOD BASED ON SIGNAL PROXY

(71) Applicant: ZHEJIANG UNIVERSITY, Hangzhou (CN)

(72) Inventors: Chunyi SONG, Hangzhou (CN); Zhihui CAO, Hangzhou (CN); Junjie LI, Hangzhou (CN); Yuying SONG, Hangzhou (CN); Zhiwei XU, Hangzhou (CN)

(21) Appl. No.: 17/834,967

(22) Filed: Jun. 8, 2022

Related U.S. Application Data
(63) Continuation of application No. PCT/CN2021/109105, filed on Jul. 29, 2021.

(30) Foreign Application Priority Data
Jan. 15, 2021 (CN) 202110056412.7

(51) Int. Cl. G01S 7/40; G08B 29/04

(52) U.S. Cl. CPC G01S 7/40; G08B 29/04

(57) ABSTRACT

Disclosed is a multitarget constant false alarm rate detection method based on the signal proxy, which belongs to the technical field of radar constant false alarm rate detection. The method realizes target detection by utilizing the correlation between linear measurements of the radar intermediate frequency signal and the sensing matrix. To achieve a desired false alarm rate, the method determines the threshold by estimating the distributed parameters of the reduced sample set obtained by removing the detected targets from the original sample set. The method provided by the present disclosure can adapt to the sparsity of the signals, realize target detection without relying on the pre-estimated environmental background level, and effectively mitigate the multitarget shadowing effect.

### CROSS-REFERENCE TO RELATED APPLICATIONS

The present application is a continuation of International Application No. PCT/CN2021/109105, filed on Jul. 29, 2021, which claims priority to Chinese Application No. 202110056412.7, filed on Jan. 15, 2021, the contents of both of which are incorporated herein by reference in their entireties.

### TECHNICAL FIELD

The present disclosure belongs to the technical field of Frequency Modulated Continuous Wave (FMCW) radar multitarget Constant False Alarm Rate (CFAR) detection, in particular to a multitarget CFAR detection method based on the signal proxy.

### BACKGROUND

A CFAR detection method achieves stable target detection performance of FMCW radar systems and avoid the malfunction of a radar receiver caused by a high false alarm rate. However, most of the existing CFAR detection methods achieve target detection relying on the estimation of the background level of a target-clutter environment. In multitarget scenes, interfering targets lead to inaccurate background level estimation, and the performance of radar target detection will decrease accordingly. Therefore, the research on the CFAR detection method in a multitarget scene has attracted extensive attention.

In conventional CFAR detection methods, the multitarget shadowing effect caused by interfering targets in the reference cells leads to inaccurate background level estimation and further leads to an excessively high detection threshold, resulting in the degradation of the detection performance of the radar system.

To mitigate the multitarget shadowing effect, some improved detection methods truncate the outliers of the signal samples before the background level estimation, which improves the detection performance of the radar in multitarget scenes. However, these methods still depend on the detection threshold determined by the pre-estimated background level to achieve target detection, and cannot effectively reduce the influence of interfering targets.

### SUMMARY

The purpose of the present disclosure is to provide a multitarget constant false alarm rate detection method based on the signal proxy, which achieves target detection without relying on a pre-estimated background level. The specific technical solution is as follows:

A multitarget constant false alarm rate detection method based on the signal proxy, including the following steps:

S1: inputting an intermediate frequency signal s to be detected, obtaining the linear measurements y of the intermediate frequency signal by using a sensing matrix A, y=As, and solving the signal proxy r, r=A*y;

S2: finding an index λ corresponding to a target with the least correlation and outputting a target set Λ;

S3: obtaining the reduced sample \tilde{x} by truncating an original background sample x using the target set Λ, modeling the reduced sample \tilde{x} in a statistically rigorous way, and determining a value of a scale parameter σ by maximum likelihood estimation; setting an desired false alarm rate P_{FA}, and calculating a false alarm regulation threshold T_{fa}; eliminating targets in the target set A below T_{fa} according to the calculated false alarm regulation threshold, and outputting a detection result.

Furthermore, the signal proxy r in S1 is specifically determined as follows:

S1.1: performing matrix multiplication on the input intermediate frequency signal s and the sensing matrix A, s∈ [symbol] ^{N×1}, A∈ [symbol] ^{n+N} to obtain the linear measurements of the intermediate frequency signal, y=As, where the sensing matrix A is a random Gaussian measurement matrix, A=(a₁, a₂, . . . , a_{N});

S1.2: obtaining the signal proxy r of the linear measurements y for the sensing matrix A, r=A*y, where the signal proxy reflects the energy intensity of the target and the clutter.

Furthermore, the target set A is specifically determined in the step S2 in the following way:

S2.1: sorting the signal proxies in a descending order to obtain r^{d}=Sort(r)= [symbol] aⱼ^{d},y [symbol] , j=1,2, . . . , N, where d is a descending order mark, and N is the signal size;

S2.2: determining the index of the target with the least correlation

$$λ = arg {min}_{j} ( {‖ ( {n}_{1} j , {n}_{2} 〈 {a}_{j}^{d} , y 〉 ) ‖}_{2}^{2} + {n}_{1} {‖ x ‖}_{0} ) ,$$

where n₁=1/N, n₂=1 [symbol] aⱼ^{d},y [symbol] , ∥⋅∥ₚ denotes a norm [symbol] ₚ, namely ∥x∥ₚ=(Σxᵢ^{p})^{1/p};

S2.3: selecting the index of the top λ largest elements in the signal proxy r to obtain the target set Λ as an output of the signal proxy detector.

Furthermore, the scale parameter σ and the false alarm regulation threshold T_{fa} are specifically determined in the following way:

S3.1: obtaining the reduced sample \tilde{x} by eliminating the target set Λ output in step S2 from the original background sample x;

S3.2: modeling the reduced sample with truncated Rayleigh distribution f_{\tilde{X}}(x), which satisfies f_{\tilde{X}}(x)=f_{X}(x≤α), where α denotes a truncation depth;

S3.3: determining a likelihood function [symbol] (σ|\tilde{x}) according to a probability density function of the truncated distribution of the reduced sample:

$$\begin{matrix}ℒ ( σ \vert \tilde{x} ) = {\prod }_{i = 1}^{N} {f}_{\tilde{X}} ( {\tilde{x}}_{i} \vert σ ) \\ = \frac{exp ( - \frac{1}{2 {σ}^{2}} {\sum }_{i = 1}^{N} {\tilde{x}}_{i}^{2} )}{{{σ}^{2 N} ( 1 - {e}^{- {α}^{2} / 2 {σ}^{2}} )}^{N}} {\prod }_{i = 1}^{N} {\tilde{x}}_{i}\end{matrix} \qquad ( 1 )$$

calculating an estimated value of the scale parameter \hat{σ}² by a maximum likelihood estimation, ∂ log L(σ|\tilde{x})/∂σ²=0:

$${\hat{σ}}^{2} \frac{1}{2 N} {\sum }_{i = 1}^{N} {\tilde{x}}_{i}^{2} + \frac{{α}^{2}}{2 ( {e}^{{α}^{2} / 2 {\hat{σ}}^{2}} - 1 )} ; \qquad ( 2 )$$

S3.4: according to the relationship between the desired false alarm rate P_{FA} and a cumulative distribution function F_{X}(⋅) of X, obtaining the following equation:

P_{FA}=1−F_{X}(T_{fa})=e^{-T}^{_{fa}}^{²}^{/2∂}^{²}⁾ (3);

S3.5: calculating the false alarm regulation threshold T_{fa} according to equations (2) and (3):

T_{fa}=\sqrt{−2\hat{σ}² log P_{FA}} (4).

The present disclosure has the following beneficial effects:

The multitarget constant false alarm rate detection method based on the signal proxy of the present disclosure focuses on FMCW radar multitarget detection field, and achieves the target detection by using a new detection algorithm without relying on the detection threshold determined by the pre-estimated background level, and comprehensively and effectively mitigates the multitarget shadowing effect.

### BRIEF DESCRIPTION OF DRAWINGS

In order to more clearly explain the examples of the present disclosure or the technical solutions in the prior art, the drawings used in the description of the examples or the prior art will be briefly introduced below.

FIG. 1 is a schematic diagram of a multitarget scene of a preferred embodiment of the present disclosure.

FIG. 2 is a flow diagram of a multitarget constant false alarm rate detection method based on the signal proxy.

FIG. 3 is the comparison results between the performance of the method of the present disclosure and the upper bound and the performance of the existing CFAR detection method.

### DESCRIPTION OF EMBODIMENTS

The purpose and effect of the present disclosure will become more explicit from the following detailed description of the present disclosure according to the drawings and preferred embodiments. It should be appreciated that the specific embodiments described here are only used to explain, rather than to limit the present disclosure.

The multitarget constant false alarm rate detection method based on the signal proxy provided by the present disclosure can effectively reduce the degradation of the radar detection performance caused by the multitarget shadowing effect in the multitarget scene, and achieve a constant false alarm rate through adaptively determined false alarm regulation threshold.

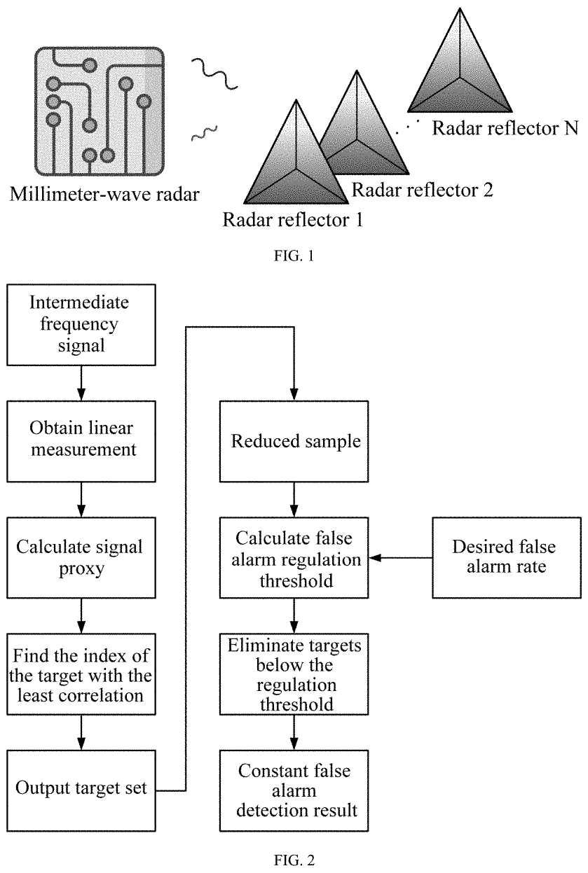

As shown in FIG. 1, in a multitarget scene, a millimeter-wave radar operating in the range of 76-81 GHz is used as a target detection sensor and ten radar reflectors with the same size are used as targets. The multitarget constant false alarm rate detection method based on the signal proxy is deployed in the radar system.

As shown in FIG. 2, the linear measurements of the radar intermediate frequency signal y is obtained and the signal proxy r is calculated in step S1, and they are both complex vectors with the size of 1024. In step S2, the index λ of the target with the least correlation is determined to be 17, and the target index set is output as [42;43;48;49;50;51;76;77;78;80;81;82;94;97;114;119;129]. In step S3, the reduced sample \tilde{x} is obtained, and the false alarm regulation threshold T_{fa} is determined to be 2.2653×10⁴. Then, the targets below the regulation threshold are eliminated, and finally the detection results are output as [42,50,73,76,81,94,97,114,119,129].

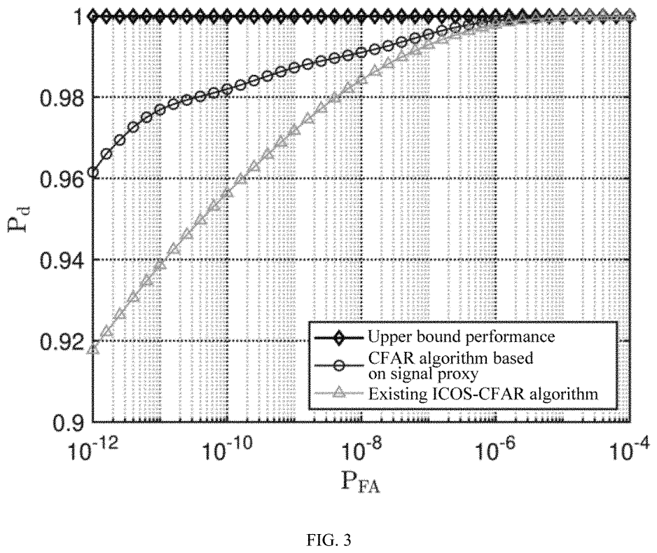

FIG. 3 is a comparison of Receiver Operating Characteristic (ROC) curves of various detection methods in the test scene. The results show that the detection performance of the method of the present disclosure is superior to the existing CFAR detection method and is close to the upper bound performance, indicating that the CFAR detection method proposed in this application can effectively mitigate the multitarget shadowing effect and achieves robust detection performance in multitarget scenes.

It can be appreciated by those skilled in the art that the above description is only the preferred examples of the present disclosure, and is not used to limit the present disclosure. Although the present disclosure has been described in detail with reference to the foregoing examples, those skilled in the art can still modify the technical solutions described in the foregoing examples or replace some of their technical features equivalently. Within the spirit and principle of the present disclosure, the modifications, equivalent replacements and the like shall fall within the scope of protection of the present disclosure.

What is claimed is:

1. A multitarget constant false alarm rate detection method based on the signal proxy, comprising the following steps:
S1: inputting an intermediate frequency signal s to be detected, obtaining the linear measurements y of the intermediate frequency signal by using a sensing matrix A, y=As, and solving the signal proxy r, r=A*y;
S2: finding an index λ corresponding to a target with the least correlation and outputting a target set Λ, which is specifically carried out in the following way:
S2.1: sorting the signal proxies in a descending order to obtain r^{d}=Sort(r)= [symbol] aⱼ^{d},y [symbol] , j=1,2, . . . , N, where d is a descending order mark, and N is the signal size;
S2.2: determining the index of the target with the least correlation
$$λ = arg {min}_{j} ( {‖ ( {n}_{1} j , {n}_{2} 〈 {a}_{j}^{d} , y 〉 ) ‖}_{2}^{2} + {n}_{1} {‖ x ‖}_{0} ) ,$$
where n₁=1/N, n₂=1 [symbol] aⱼ^{d},y [symbol] , ∥⋅∥ₚ denotes a norm [symbol] ₚ, namely ∥x∥ₚ=(Σxᵢ^{p})^{1/p};
S2.3: selecting the index of the top λ largest elements in the signal proxy r to obtain the target set Λ as an output of the signal proxy detector;
S3: obtaining the reduced sample \tilde{x} by truncating an original background sample x using the target set Λ, modeling the reduced sample \tilde{x} in a statistically rigorous way, and determining a value of a scale parameter σ by maximum likelihood estimation; setting an desired false alarm rate P_{FA}, and calculating a false alarm regulation threshold T_{fa}; eliminating targets in the target set Λ below T_{fa} according to the calculated false alarm regulation threshold, and outputting a detection result;
where the scale parameter σ and the false alarm regulation threshold T_{fa} are specifically determined as follows:
S3.1: obtaining the reduced sample \tilde{x} by eliminating the target set Λ output in step S2 from the original background sample x;
S3.2: modeling the reduced sample with truncated Rayleigh distribution f_{\tilde{X}}(x), which satisfies f_{\tilde{X}}(x)=f_{X}(x≤α), where α denotes a truncation depth;
S3.3: determining a likelihood function [symbol] (σ|\tilde{x}) according to a probability density function of the truncated distribution of the reduced sample:
$$\begin{matrix}ℒ ( σ \vert \tilde{x} ) = {\prod }_{i = 1}^{N} {f}_{\tilde{X}} ( {\tilde{x}}_{i} \vert σ ) \\ = \frac{exp ( - \frac{1}{2 {σ}^{2}} {\sum }_{i = 1}^{N} {\tilde{x}}_{i}^{2} )}{{{σ}^{2 N} ( 1 - {e}^{- {α}^{2} / 2 {σ}^{2}} )}^{N}} {\prod }_{i = 1}^{N} {\tilde{x}}_{i}\end{matrix} , \qquad ( 1 )$$
calculating an estimated value of the scale parameter \hat{σ}² by a maximum likelihood estimation, ∂ log [symbol] (σ|\tilde{x})/∂σ²=0:
$${\hat{σ}}^{2} \frac{1}{2 N} {\sum }_{i = 1}^{N} {\tilde{x}}_{i}^{2} + \frac{{α}^{2}}{2 ( {e}^{{α}^{2} / 2 {\hat{σ}}^{2}} - 1 )} , \qquad ( 2 )$$
S3.4: according to the relationship between the desired false alarm probability P_{FA} and a cumulative distribution function F_{X}(⋅) of X, obtaining the following equation:
P_{FA}=1−F_{X}(T_{fa})=e^{-T}^{_{fa}}^{²}^{/2∂}^{²}⁾ (3);
S3.5: calculating the false alarm regulation threshold T_{fa} according to equations (2) and (3):
T_{fa}=\sqrt{−2\hat{σ}² log P_{FA}} (4).

2. The multitarget constant false alarm rate detection method based on the signal proxy according to claim 1, where the signal proxy r in S1 is specifically determined in the following way:
S1.1: performing matrix multiplication on the input intermediate frequency signal s and the sensing matrix A, s∈ [symbol] ^{N×1}, A∈ [symbol] ^{n+N} to obtain the linear measurements of the intermediate frequency signal, y=As, where the sensing matrix A is a random Gaussian measurement matrix, A=(a₁, a₂, . . . , a_{N});
S1.2: obtaining the signal proxy r of the linear measurements y for the sensing matrix A, r=A*y, where the signal proxy reflects the energy intensity of the target and the clutter.
